(19) United States
(12) Patent Application Publication
(10) Pub. No.: US 2009/0008113 A1
(43) Pub. Date: Jan. 8, 2009

(54) Post Driver

(75) Inventors: Garry Lyons, Victoria (AU); Jason Yole, Victoria (AU); Darren Macgill, Victoria (AU)

Correspondence Address: HARNESS, DICKEY & PIERCE, P.L.C., P.O. BOX 828, BLOOMFIELD HILLS, MI, 48303, US

(73) Assignees: Boorun Pty. Ltd., Victoria (AU); Dark Horse Pty. Ltd., Victoria (AU)

(21) Appl. No.: 12/132,137

(22) Filed: Jun. 3, 2008

(30) Foreign Application Priority Data
Jun. 5, 2007 (AU) 2007903036

(51) Int. Cl. B25D 17/32; E02D 7/08

(52) U.S. Cl. 173/48; 173/93; 173/114; 173/194

(57) ABSTRACT

A post driver has a housing of tubular form extending substantially vertically, and weight telescopically mounted within the housing for movement between an extended position raised above the housing and a lowered position. A strike pad projects from the weight to drive a post into a hole drilled in the ground. A fluid cylinder mounted within the housing extends from a lower part of the housing to the interior of the weight and is operable to raise the weight to its extended position whereby the weight can then fall to a lower position at which its strike pad engages the upper end of the post.

### CROSS-REFERENCE TO RELATED APPLICATIONS

This application claims the benefit of Australian patent application serial number 2007903036, filed on Jun. 5, 2007. The disclosure of the above application is incorporated herein by reference.

### FIELD

The present disclosure relates to a post driver for driving a post into the ground.

### BACKGROUND

Post drivers conventionally comprise a powered auger for drilling a hole into the ground and a weight for driving the post into the hole by a series of hammer blows. The weight is carried by a tower to which the auger is also mounted for movement between operative and stowed positions. The weight is raised hydraulically to the full height of the tower and is then allowed to fall to impart a hammer blow to the post which is held in the path of the weight. The weight is mounted to the tower in cantilever fashion so as to extend outwardly from the tower, typically rearwardly from the tower when the post driver is mounted at the rear of a tractor, and the maximum height of the weight corresponds to the height of the tower. In order to maximize the energy of the falling weight, the tower is made as tall as practical but a tall tower can give rise to difficulties in transportation and storage and also in obtaining working access under trees and within sheds. Moreover, the use of a tall tower can give rise to stability problems if used with smaller sized tractors. The cantilever mounting of the heavy weight can sometimes give rise to wear problems in the slide bearings for the weight.

### SUMMARY

According to the present disclosure there is provided a post driver comprising a housing extending substantially vertically, a weight mounted within the housing for movement between an extended position raised above the housing and a lowered position retracted within the housing, a strike pad projecting from the weight to drive a post into a hole drilled in the ground, and an auger assembly for drilling the hole.

In a preferred embodiment of the invention, the weight has an external cross-section complementary to that of the internal cross-section of the housing with the weight being guided for movement by co-operating slide bearings between opposed faces of the weight and housing. The weight is of hollow construction and is raised to its extended position by operation of a fluid cylinder extending upwardly from the lower part of the housing into the interior of the hollow weight. Advantageously, in the retracted position of the weight it is retracted within the housing over substantially its entire length.

Preferably, the strike pad is mounted to the weight in a selected one of a plurality of different positions along the height direction of the weight to provide adjustment to suit different lengths of the post to be driven into the ground.

The zone of movement of the strike pad upon movement of the weight defines the operative zone of the post driver and, preferably, the housing is shaped so as to locate and centre a post within the operative zone.

The auger assembly is mounted to the housing for movement between a stowed position remote from the operative zone and an operative position in the operative zone. In the operative position, the auger assembly is attached to the strike pad. The movement of the auger assembly between its stowed and operative positions can be effected manually or by a powered system. For manual movement, a main frame of the auger assembly is slid laterally between the stowed and operative positions. A motor and drive shaft to which the auger is attached is mounted to the main frame for sliding movement to permit adjustment according to the diameter of the auger.

Advantageously, the operative zone of the post driver is enclosed by a cage to prevent access thereto during operation. Preferably, the cage is mounted for swinging movement to an open position in which access to the operative zone is afforded but operation of the post driver is inhibited. Preferably this achieved by a system for locking the weight at least against any substantial downwards movement. In one form the locking system comprises a locking dog engageable with the weight when the cage is moved to its open position.

Preferably the post driver has an optional attachment mountable to the housing to extend in alignment with, but outside of, the operative zone for engagement with fencing wires of an existing fence to push same away from the operative zone whereby to permit drilling and post driving onto the existing fence line. Such an attachment also has utility to some existing types of post driver.

Accordingly, another aspect of the invention provides an attachment for coupling to a post driver in alignment with and outside of its operative zone whereby to push fencing wire of an existing fence out of the operative zone to permit the operative zone to align with the existing fence line.

The attachment may take the form of a vertical rod held outwardly from a housing of the post driver by a support such as a horizontal arm.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a view from the rear of a post driver in accordance with the preferred embodiment when mounted to the rear of a tractor, the post driver being shown in a condition in which its driving weight is in a partially raised extended position relative to the main housing of the driver;

FIG. 2 is a more detailed view, corresponding to FIG. 1;

FIG. 3 shows more schematically the housing and weight, with the weight fully retracted into the housing;

FIG. 4 is a plan view corresponding to FIG. 3;

FIG. 5 is a plan view similar to FIG. 4, but showing the positions of slide bearings on opposing faces of the weight and housing;

FIG. 6 is a detailed view showing an auger assembly in its operative position coupled to the strike pad of the weight;

FIG. 7 is a rear view showing a safety cage in its closed position to prevent access to the operative zone of the post driver;

FIG. 8 is a side view showing locking slots along the length of the driver for co-operation with a locking dog actuated by the safety cage;

FIG. 9 is a detailed view showing the safety cage in its closed position and the locking dog in its released position;

FIG. 10 shows the locking dog in its locking position in engagement with one of the locking slots in the weight in response to opening movement of the cage; this Figure also shows a spring linkage between the cage and locking dog;

FIG. 11 is a view from the rear showing an optional attachment to the housing of the post driver to displace existing fence wire from the fence line; and

FIG. 12 is a side view equivalent to FIG. 11.

### DETAILED DESCRIPTION

The following description is merely exemplary in nature and is not intended to limit the present disclosure, application, or uses.

The post driver is principally intended for mounting at the rear of a vehicle, such as a tractor, or at the front of a vehicle such as a front end loader. It will, however, be described with reference to its mounting at the rear of a tractor in which case the operative side of the post driver is its rear side; when mounted at the front of a vehicle its orientation will be reversed so that its operative side will be its front side.

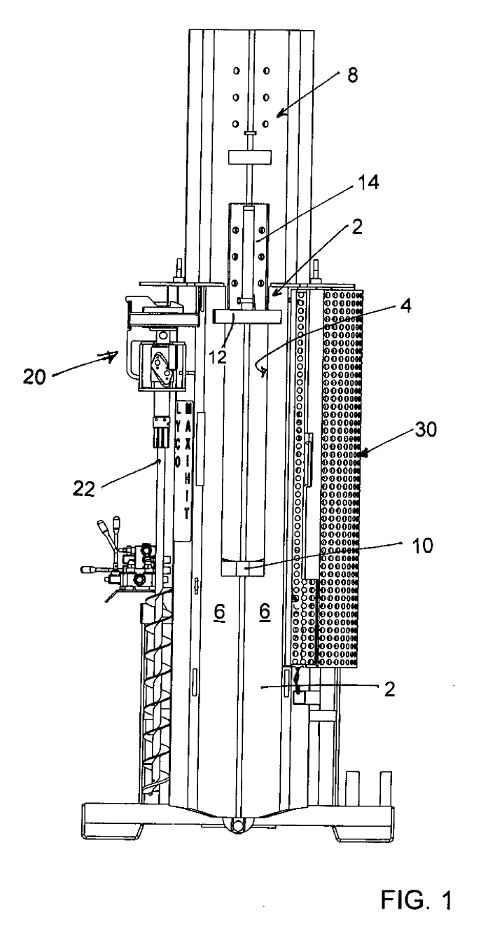

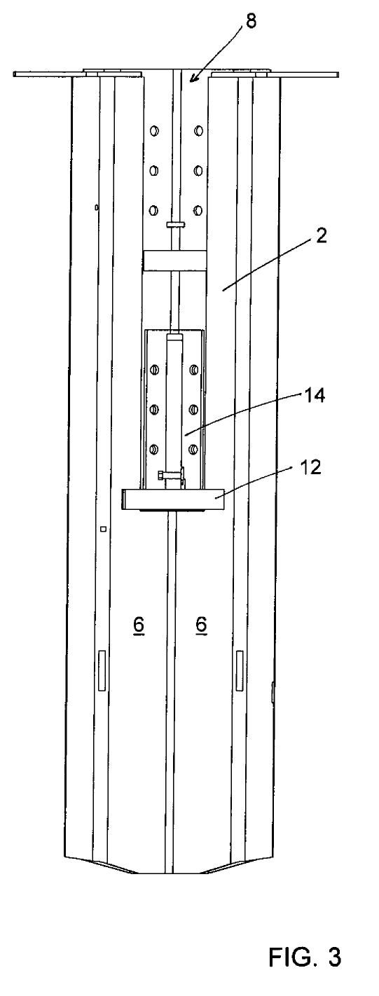

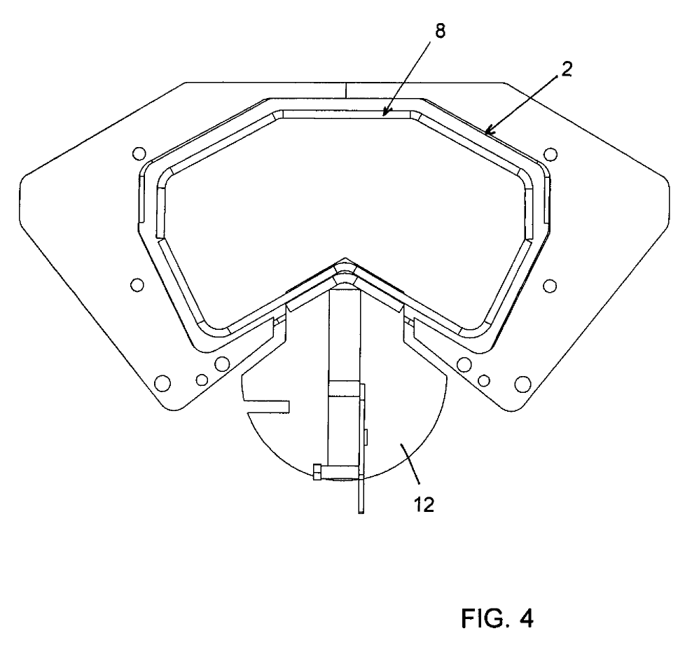

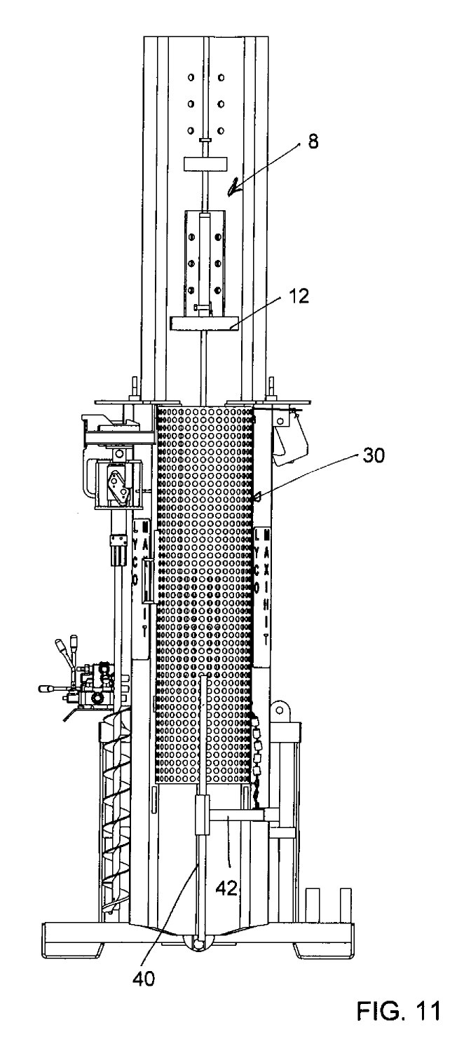

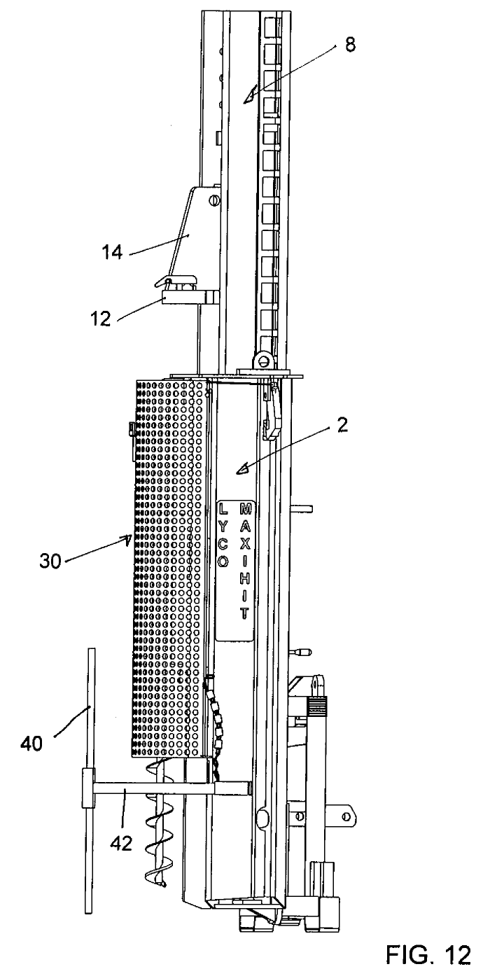

The post driver of the preferred embodiment of the invention comprises a vertical main housing 2 or column of hollow form. The housing is of a polygonal cross-section defined by a series of inclined walls as shown in FIGS. 3 and 4. At its rear face (as considered when mounted at the rear of a tractor), the housing 2 is open to define a central vertical slot 4 which extends from the upper end of the housing partway along the length of the housing. The rear side of the housing is defined by a pair of convergent walls 6 which, in the lower part of the housing 2, define a V-shaped configuration to locate a post to be driven by the driver as will be described subsequently. The housing 2 is fabricated from thick steel plate. A driving weight 8 is telescopically mounted within the housing 2 for vertical movement between a raised position (beyond that as shown in FIG. 1 but actually shown in FIGS. 11 and 12) in which it extends significantly from the housing 2 and a lowered position in which it is retracted within the housing 2 over substantially its entire length (see FIG. 3). The weight 8 is also fabricated from thick steel plate and is of complimentary cross-section to that of the housing. Slide bearings, to be described later, interposed between adjacent faces of the weight 8 and housing 2 effect, due to the cross-sectional shape of the weight and housing, a self-centering action to maintain the vertical axis of the weight aligned with that of the housing. A fluid cylinder, for example a hydraulic cylinder, mounted within the housing 2 on the vertical axis thereof and extends from the base of the housing 2 into the interior of the weight 8. The cylinder is actuable to raise the weight to its an extended raised position from which it is allowed to fall to impact a hammer blow to a post, as will be described. Part of the fluid cylinder is shown at 10 in FIG. 1.

The body of the weight 8 carries a rearwardly-projecting strike pad 12 to engage the top of a post located externally of the housing 2 between the convergent rear walls 6 thereof. The strike pad 12 is attached to the weight 8 by a rigid bracket 14 of sufficient strength to carry the hammer force which will be imparted to the post when the weight 8 falls from its raised position upon release of pressure within the fluid cylinder. Although when the weight 8 is in its fully raised position the strike pad 12 and its mounting bracket 14 will be located above the housing, as the weight falls the strike pad 12 and bracket 14 will move into the vertical slot 4 at the rear face of the housing (see FIGS. 1 to 3).

Advantageously, the strike pad 12 and bracket 14 are bolted to the weight 8 so as to be adjustable in height to suit different lengths of post. In practice, it is envisaged that a choice of two positions will be provided, one suitable for posts of approximately two meters in length and the other for posts of approximately three meters in length.

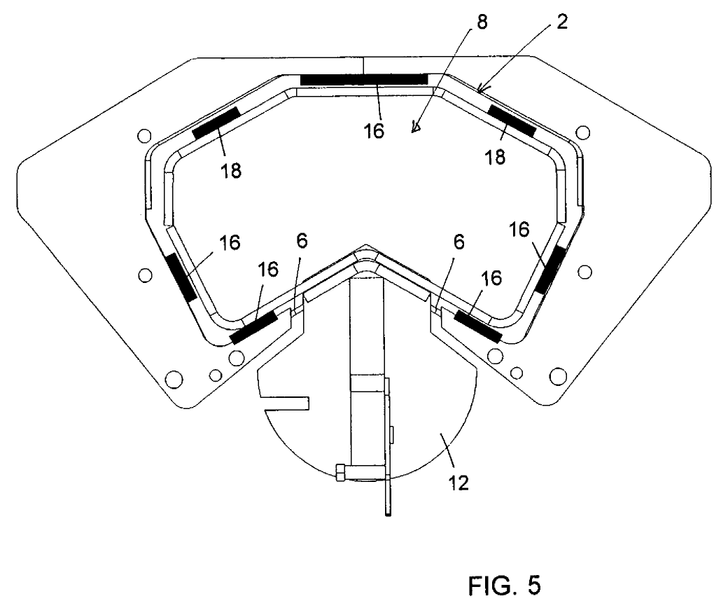

Slide bearings in the form of pads of nylon or other low friction hard-wearing plastics material are attached to the inner faces of the housing 2 at the upper end thereof and the outer faces of the weight 8 at the lower end thereof. The location of the two sets of bearing pads is shown in FIG. 5 in which the pads carried by the housing 2 are designated 16 and those carried by the weight 8 are designated 18. It will be seen that the pads of the respective sets are distributed around the peripheries of the two components and due to the cross-sectional shape of the components and the position of the pads, the pads will have the effect of ensuring that the weight 8 is maintained substantially centered within the housing 2 despite the fact that the weight 8 is not a close fit within the housing 2. It is to be understood that pads 16 carried by the housing 2 may be substituted by pads 18 carried by the weight 8 in corresponding positions, and, similarly pads 18 carried by the weight 8 may be substituted by pads 16 in corresponding positions. The pads 16, 18 are of a rectangular shape and it is preferred that the pads are located in rectangular frames welded to the housing and weight so that the face of the pad 16, 18 is located beyond the face of the frame. It is preferred that the pads simply sit within their respective frames without the need for screws or the like to retain the pads as, once installed, the pads will be restrained from release from the frame by co-operation with the opposing face of the weight or housing. This means that the pads can quickly be replaced for routine servicing and all that is necessary in that case is to lift the weight 8 to a height to expose the pads to enable the worn pads lifted out of the frames and replacement pads put back in.

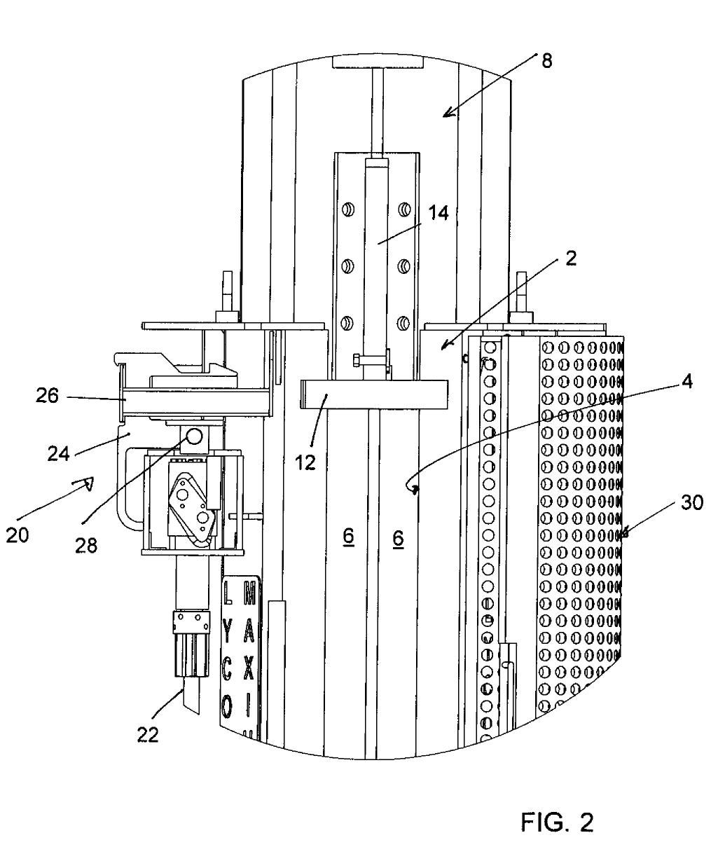

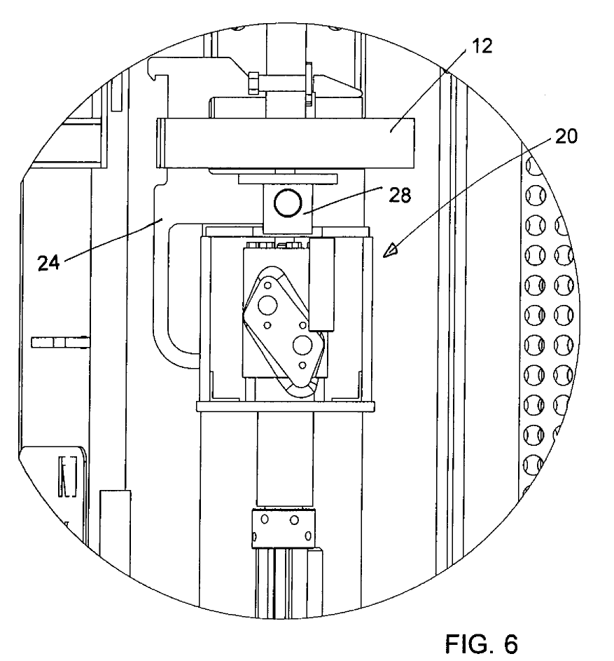

An auger assembly 20 comprising a drive motor, for example a hydraulic motor, and drive shaft to which an auger 22 is detachably connected, is mounted for lateral sliding movement between a stowed position to a lateral side of the housing 2 outside of the zone of action of the strike pad 12 (as shown in FIGS. 1 and 2) and an operative position in which the auger assembly 20 is coupled to the strike pad 12 as shown in FIG. 6. The auger assembly 20 has a main frame 24 by which it is slidably mounted to a stowage bracket 26 (see FIG. 2) carried by the housing and to which it is releasably latched to maintain the auger assembly 20 in its stowed position. To couple the auger assembly 20 to the strike pad 12, the weight 8 is set by operation of its hydraulic cylinder to a predetermined height at which the strike pad 12 is aligned with the stowage bracket 26, the latch is released, and the auger assembly 20 is then slid sideways to engage with the strike pad 12. In its fully engaged position, the auger assembly 20 is fully removed from the bracket 26 and it is securely fastened to the strike pad 12 (see FIG. 6) by means of the latch which engages latching structure at the upper face of the strike pad. In this condition, the main frame 24 of the auger assembly 20 is beneath the strike pad 12 so that during drilling with the weight released, the weight acting on the main frame 24 will assist driving the auger into the ground. Advantageously, the motor with drive shaft and auger attached thereto is mounted to the main frame 24 by a carriage 28 which is able to slide through a limited distance in a fore-aft direction to enable the operative position of the auger to be adjusted relative to the rear side of the housing 2 in accordance with the diameter of the auger and hence the diameter of the post being driven. In this regard, as the convergent rear side of the housing (formed by the convergent walls 6) acts as a locator and guide for the post during driving of the post into the hole previously formed by the auger, for larger diameter posts the axis of the hole will need to be displaced further outwardly from the housing.

The movement of the auger assembly 20 between its stowed and operative positions is effected manually and although with the mounting system described this can be readily achieved, alternatively the post driver can incorporate a powered system for moving the auger between its stowed and operative positions. Such a powered system may be as described in our earlier Australian patent 746198 and Australian patent application 2005200558 the disclosure of which is hereby incorporated by reference.

As mentioned above, during driving of the post it is located and guided by the convergent walls 6 forming the rear side of the housing 2 and for this purpose the post can be held against the rear side of the housing 2 either by a chain carrying a series of roller sleeves or by a mechanical clamping arm such as described in the aforementioned Australian patent application 2005200558.

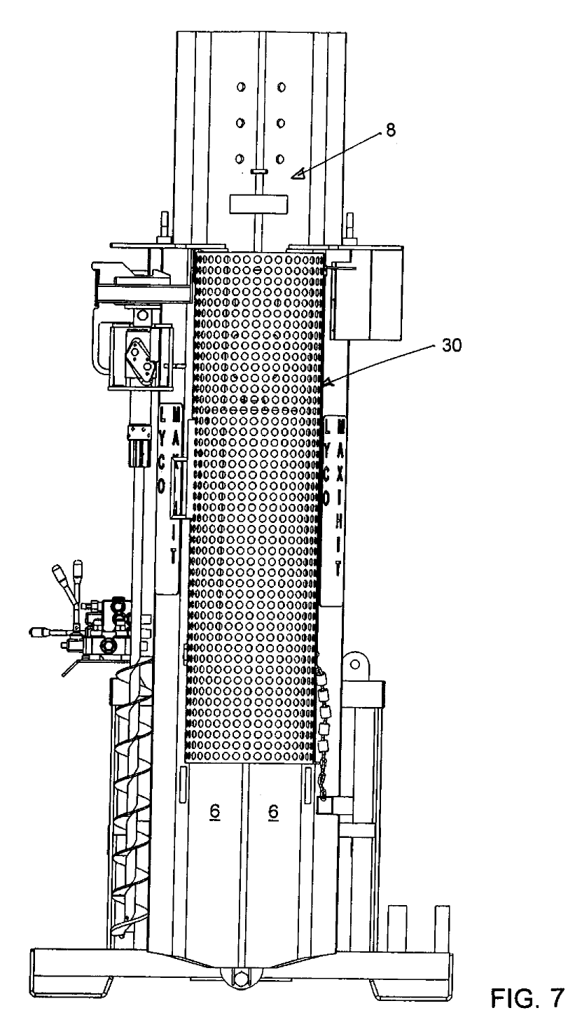

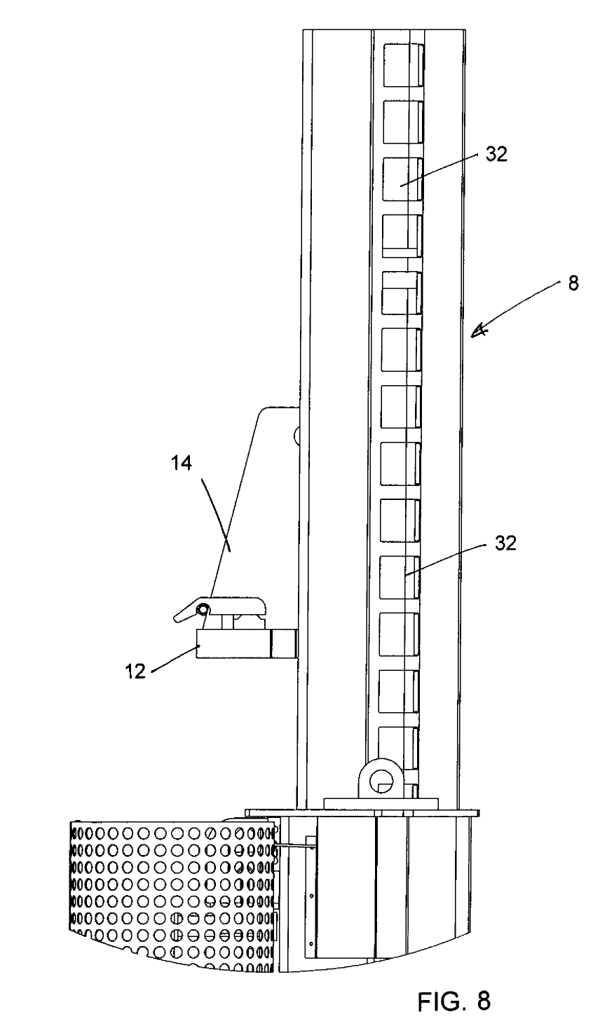

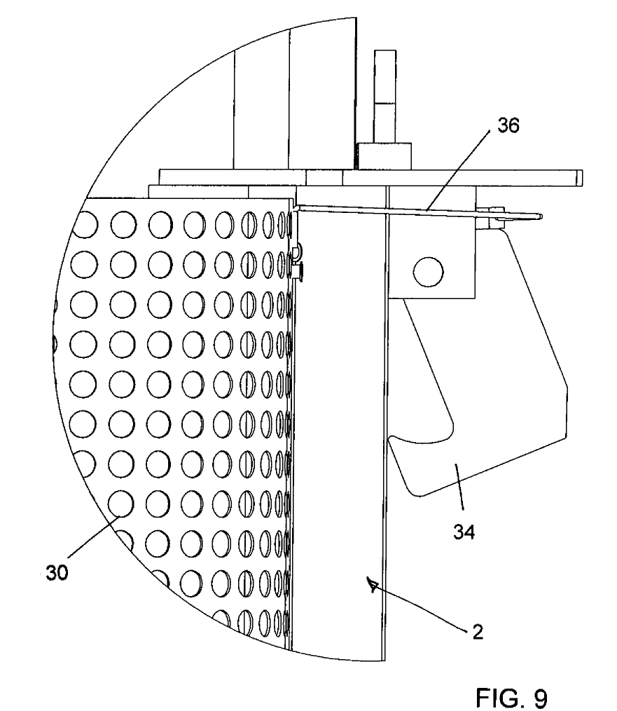

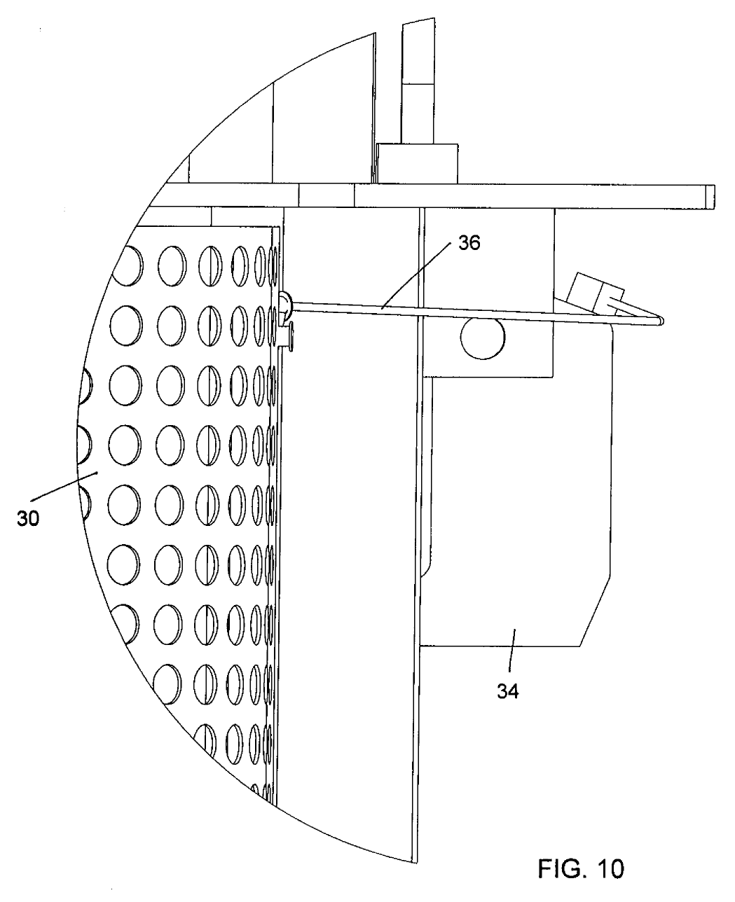

When in use either when drilling a hole by means of the auger or driving a post into the hole, the operative zone of the post driver (effectively, the vertical zone of movement of the strike pad 12) is protected by means of a safety cage 30. In the form shown, the safety cage 30 is of semi-cylindrical form which is mounted to the housing 2 for swinging movement about a vertical axis between a closed position in which it prevents access of an operator into the operative zone (see FIG. 7) and an open position (see FIGS. 1 and 2) in which an operator is able to obtain access to the operative zone as will be needed when the auger assembly is to be moved between its stowed and operative positions, when the post is to be located for driving into the hole, and when post driving is completed to enable the post driver to be moved away from the post. The safety cage 30 is linked to a positive locking system for the weight 8 which ensures that when the cage is opened the weight 8 cannot move, or at most can only be moved through a small distance, one or two centimeters at most. In the embodiment shown, the locking system comprises a row of closely spaced slots 32 arranged along the length of the weight 8 at one side thereof as shown in FIG. 8. These slots co-operate with a large locking dog 34 pivotally mounted to the housing 2 to swing between an engaged locking position in which the dog 34 extends through an aperture in the side of a housing into an adjacent one of the slots 32 in the weight 8 so that the weight cannot displace past the dog 34, and a released position in which the dog 34 is withdrawn from the slot. The dog 34 is shown in a released position in FIG. 9 and its locking position in FIG. 10. The safety cage 30 is linked to the dog 34 by a linkage which moves the dog 34 to its locking position when the cage 30 is opened and to its released position when the cage is closed. The linkage is not a rigid linkage but, rather, is a spring linkage which applies a spring bias to the dog 34 in a sense to move the dog towards its locking position when the cage is opened and towards its released position when the cage is closed. The reason for this is that when the cage is opened, the weight might not have been set into a position in which the dog 34 can move into the adjacent slot 32 in the weight, but instead might move into engagement with the land between two adjacent slots 32. This will be readily observable by the operator as the locking dog 34 is large and prominently visible, and minor adjustment of the height of the weight by means of the hydraulic controls will ensure that the dog 34 can then move under its spring bias into its locking position within the slot 32 to ensure that the weight is safely locked against movement until the safety cage has been closed. Even if an operator omits to take that precaution, the post driver cannot be operated with the cage open because the weight cannot move downwardly by more than the small distance needed to enable the adjacent slot 32 to move into alignment with the dog 34 at which time the dog under its spring bias will displace into its locking position.

In the embodiment shown, the spring linkage is formed by a simple torsion rod 36 (see FIGS. 9 and 10) angled at each end for engagement between stops on the cage 30 and dog 34 so that when the cage is closed the rod 36 will be pivoted to cause release of the dog 34 whereas when the cage is opened the rod 36 will be pivoted to cause locking engagement of the dog 34 but if the dog is not able to engage into the adjacent slot 32 in the weight the rod 36 will twist to provide a torsional bias to force the dog 34 into the slot 32 when the slight height adjustment of the weight occurs. It is to be understood that other types of spring linkage could alternatively be used. Other forms of interlock system, such as hydraulic or electrical could alternatively be installed between the cage and dog. However the particular form of linkage described is effective in operation and is inexpensive to produce.

In an alternative locking configuration, the locking slots 32 are formed on the rear face of the weight to one side of the strike pad 12 and a spring loaded locking dog or other locking member is mounted to the cage 30 in such a manner as to engage into an adjacent one of the locking slots when the cage 30 is moved to its open position and to release from the locking slot when the cage is closed. The spring bias acting on the locking dog operates in a similar manner to that described above.

A practical difficulty can sometimes arise in replacing a broken or loose post in an existing fence line due to the presence of the fencing wire which needs to be moved away from the zone of operation of the post driver. While there are a variety of makeshift methods by which this is often done, the post driver of the preferred embodiment of the invention includes an optional attachment which greatly facilitates this. The attachment is in the form of a vertical rod 40 carried by a horizontal extension arm 42 (see FIGS. 11 and 12). The arm 42 fits at its forward end into an inclined socket at the base of the housing 2 to one side thereof so that when mounted, the rod 40 will lie outside of the cage 30 but in line with the operative zone of the post driver, the rod being a sufficient distance behind the cage 30 so as not to interfere with its operation. All that is necessary to displace fencing wire is, with the rod 40 in position, to back the tractor up to the wire so that the post will displace the wire rearwardly by a sufficient distance for access of the post driver to drill a hole and drive the post into the existing fence line. The rod 40 and its extension arm 42 are preferably formed as separate components which, when not required can be disassembled for easy storage provided on the housing of the post driver.

It is to be understood that an attachment of this type can also be used with conventional forms of post driver.

The housing 2 and the components carried thereby including the weight, auger assembly and cage is mounted to the support structure by which it is mounted to the tractor or other vehicle. The support structure may comprise a lower frame to which the lower end of a housing is mounted by a pivot joint such that the housing can be pivoted about the joint in a lateral direction under the control of a fluid cylinder. The frame may also be pivotal in a fore-aft direction under the control of a separate cylinder and the frame may be laterally displaceable under the control of a yet further cylinder. Accordingly, by separately actuating the cylinders, the housing can be adjusted into a vertical or near-vertical orientation even when the vehicle is standing on uneven ground and the lateral adjustment of the frame itself is able to permit relatively fine lateral adjustment of the position of the housing to ensure that the post is driven in alignment with the required fence line. It is to be understood that although this range of adjustment is preferred it is not essential and simpler versions may have provision for no such adjustment or only limited adjustment.

In the post driver of the preferred embodiments of the invention, the mounting of the weight telescopically within the housing with the weight being displaceable relative to the housing between its raised and lowered positions avoids the need for a mast extending to the full height of the weight. In its lowered position the weight is substantially retracted into the housing which provides improved stability during transportation, particularly when using smaller sized tractors and difficulties are unlikely to arise in obtaining access to areas of restricted height, storage sheds for example.

What is claimed is:

1. A post driver comprising a housing extending substantially vertically, a weight mounted within the housing for movement between an extended position raised above the housing and a lowered position retracted within the housing, a strike pad projecting from the weight to drive a post into a hole drilled in the ground, and an auger assembly for drilling the hole.

2. A post driver according to claim 1, wherein the weight has an external cross-section complementary to that of the internal cross-section of the housing with the weight being guided for movement by co-operating slide bearings between opposed faces of the weight and housing.

3. A post driver according to claim 2, wherein the weight is of hollow construction and is raised to its extended position by operation of a fluid cylinder extending upwardly from the lower part of the housing into the interior of the hollow weight.

4. A post driver according to claim 3, wherein the strike pad is mounted to the weight in a selected one of a plurality of different positions along the height direction of the weight to provide adjustment to suit different lengths of the post to be driven into the ground.

5. A post driver according to claim 2, wherein the zone of movement of the strike pad upon movement of the weight defines the operative zone of the post driver, and the housing is shaped so as to locate and centre a post within the operative zone.

6. A post driver according to claim 5, wherein the housing includes a convergent wall portion engageable by the post to centre the post within the operative zone.

7. A post driver according to claim 1, wherein the auger assembly is mounted to the housing for movement between an operative position in which the auger assembly is attached to the strike pad, and a stowed position out of the zone of movement of the strike pad.

8. A post driver according to claim 7, wherein the auger assembly has a main frame slidable laterally between the stowed and operative positions, and a motor and drive shaft to which an auger is attached are mounted to the main frame for sliding movement to permit adjustment in position according to the diameter of the auger.

9. A post driver according to claim 1, wherein the zone of movement of the strike pad upon movement of the weight defines an operative zone of the post driver, the post driver further comprising a cage moveable between an open position in which operator access to the operative zone is afforded but operation of the post driver is inhibited and a closed position in which operator access to the operative zone is inhibited but operation of the post driver is enabled.

10. A post driver according to claim 9, wherein the cage is mounted for swinging movement between its open and closed positions and inhibiting of operation of the post driver is effected by mechanically locking the weight at least against any substantial downwards movement when the cage is in its open position.

11. A post driver according to claim 10, wherein movement of the cage to its open position actuates a locking member to mechanically lock the weight against any substantial downwards movement by engagement with the weight.

12. A post driver comprising a housing of tubular form extending substantially vertically, a weight telescopically mounted within the housing for movement between an extended position raised above the housing and a lowered position, a strike pad projecting from the weight to drive a post into a hole drilled in the ground, and a fluid cylinder mounted within the housing and extending from a lower part of the housing to the weight and operable to raise the weight to its extended position whereby the weight can then fall to a lower position at which its strike pad engages the upper end of the post.

13. A post driver according to claim 12, wherein the housing and weight are of complimentary polygonal cross-sections with inclined walls which act to centre the weight within the housing during its movement, and replaceable slide bearings are interposed between opposing faces of the housing and weight.

14. A post driver according to claim 13, having an attachment mountable to the housing to extend an alignment with, but outside of, the operative zone for engagement with fencing wires and an existing fence to push same away from the operative zone whereby to permit drilling and post driving onto the existing fence line.
